(19) United States
(12) Patent Application Publication
(10) Pub. No.: US 2017/0186258 A1
(43) Pub. Date: Jun. 29, 2017

(54) ELECTRONIC LOCKER

(71) Applicant: EXILANT Technologies Private Limited, Bangalore (IN)

(72) Inventors: Vishnu Sharma, Bhubaneswar (IN); Madhav Sivadas, Singapore (SG)

(73) Assignee: EXILANT Technologies Private Limited, Bangalore (IN)

(21) Appl. No.: 15/458,761

(22) Filed: Mar. 14, 2017

Related U.S. Application Data
(62) Division of application No. 14/757,967, filed on Dec. 24, 2015, now abandoned.

(30) Foreign Application Priority Data
Dec. 24, 2014 (IN) 6556/CHE/2014

(51) Int. Cl. G07C 9/00

(52) U.S. Cl. CPC G07C 9/00309; G07C 2009/00769; G07C 9/00896

(57) ABSTRACT

An apparatus may include a housing defining a compartment, wherein the housing is configured to accept at least one item within the compartment. The apparatus may also include a member coupled with the housing, wherein the member defines a container, wherein the member is configured to provide access to the compartment in a first state, and wherein the member is further configured to restrict access to the compartment in a second state. The apparatus may further include an electronic lock disposed at least partially within the container, wherein the electronic lock is configured to limit relative movement between the member and the housing in the second state. The apparatus may also include an interface routed between the compartment and the container, wherein the interface is configured to allow control of the electronic lock.

### RELATED APPLICATIONS

The present application is a divisional of U.S. patent application Ser. No. 14/757,967, filed Dec. 24, 2015, which claims priority to Indian patent application number 6556/CHE/2014, filed Dec. 24, 2014. Those applications are incorporated herein by reference in their entirety and for all purposes.

### BACKGROUND

Collateralization of personal loans by gold is a common practice in many countries. Gold can be deposited at the office of a loan provider in return for a cash loan with a certain interest rate. Gold can also be deposited in conventional locker kiosks when money is needed more urgently. Conventional locker kiosks located at hospitals are often used to secure loans to pay medical expenses.

However, the conventional locker kiosks at hospitals and other locations do not provide adequate security for gold and other valuables. For example, the same key is typically provided to the person depositing the valuables as well as the representative of the company that manages the locker kiosk. As a result, theft by such representatives is common since the locker can be opened by the representative without the person who deposited the valuables being present.

And although other conventional solutions exist for securing valuables, these conventional solutions are not appropriate for securing valuables related to collateralization. For example, bank deposit boxes are not used for collateralization since they are often located remotely from hospitals and other facilities where money is needed urgently. Additionally, depositing and withdrawing items from deposit boxes is an involved and time consuming process. Conventional lockers and safes are also not suitable for collateralization as they provide insufficient security.

### SUMMARY

In one embodiment, an apparatus may include a housing defining a compartment, wherein the housing is configured to accept at least one item within the compartment. The apparatus may also include a member coupled with the housing, wherein the member defines a container, wherein the member is configured to provide access to the compartment in a first state, and wherein the member is further configured to restrict access to the compartment in a second state. The apparatus may further include an electronic lock disposed at least partially within the container, wherein the electronic lock is configured to limit relative movement between the member and the housing in the second state. The apparatus may also include an interface routed between the compartment and the container, wherein the interface is configured to allow control of the electronic lock.

### BRIEF DESCRIPTION OF THE DRAWINGS

The present invention is illustrated by way of example, and not by way of limitation, in the figures of the accompanying drawings and in which like reference numerals refer to the same or similar elements.

FIG. 1 shows a top view of an electronic locker in accordance with one embodiment.

FIG. 2 shows a side view of an electronic locker in accordance with one embodiment.

FIG. 3 shows a top view of an electronic locker defining multiple containers in accordance with one embodiment.

FIG. 4 shows a side view of an electronic locker defining multiple containers in accordance with one embodiment.

FIG. 5 shows a top view of an electronic locker including a drawer in accordance with one embodiment.

FIG. 6 shows a side view of an electronic locker including a drawer in accordance with one embodiment.

FIG. 7 shows a top view of an electronic locker defining multiple containers and including a drawer in accordance with one embodiment.

FIG. 8 shows a side view of an electronic locker defining multiple containers and including a drawer in accordance with one embodiment.

FIG. 9 shows a front face of a member in accordance with one embodiment.

FIG. 10A shows a system including a plurality of electronic lockers in accordance with one embodiment.

FIG. 10B shows a system including a plurality of electronic lockers in at least one daisy chain configuration in accordance with one embodiment.

FIG. 11 shows circuitry in accordance with one embodiment.

### DETAILED DESCRIPTION

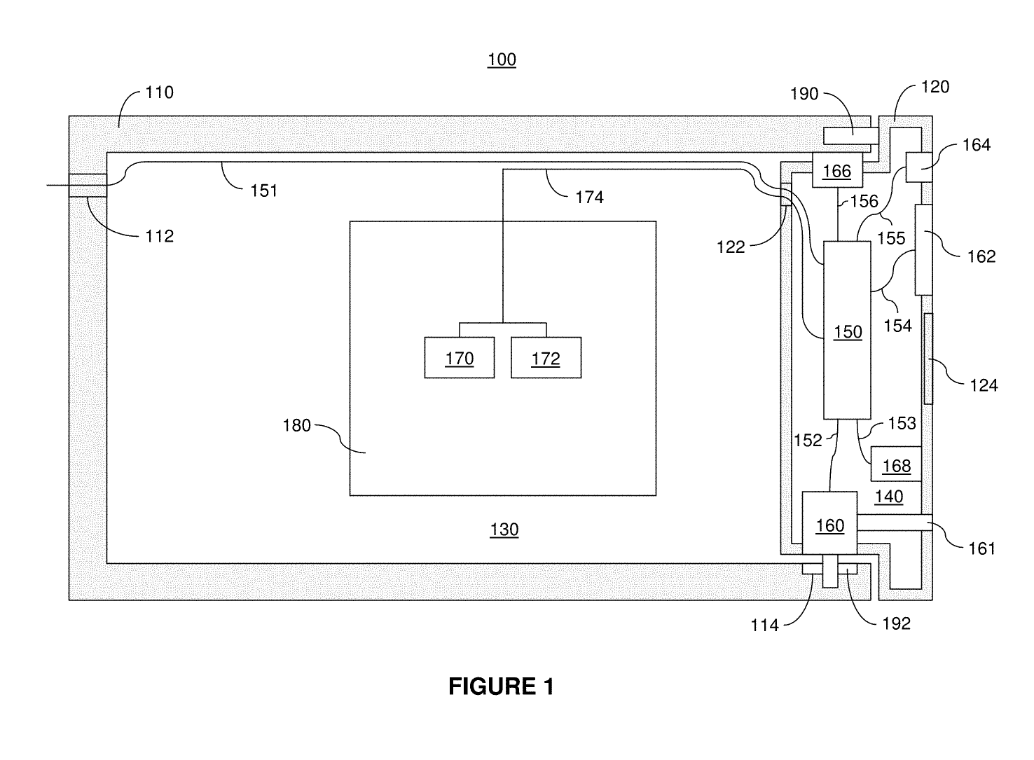

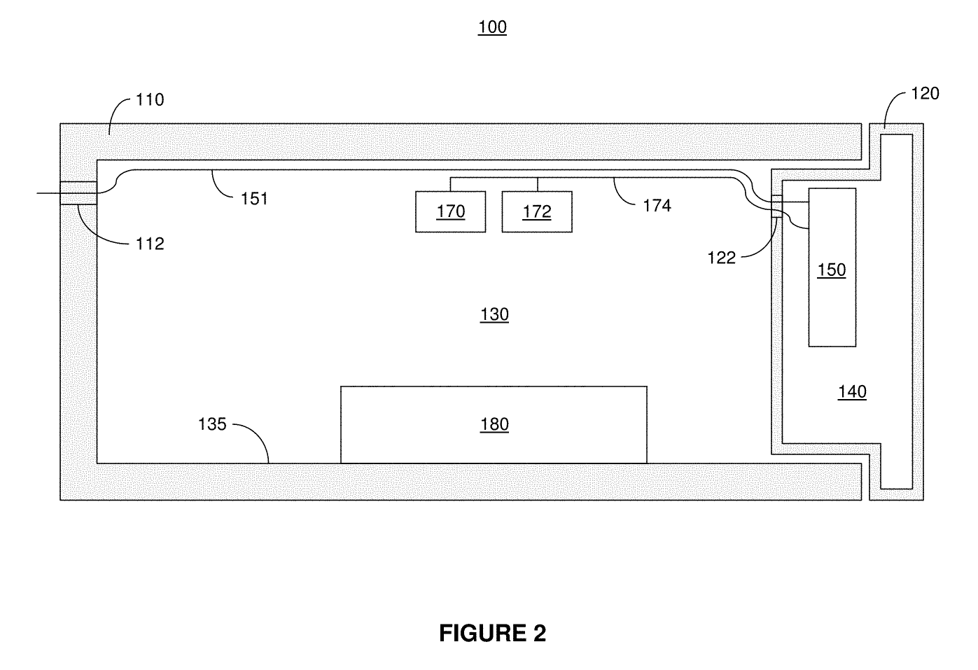

FIG. 1 shows a top view of electronic locker 100 in accordance with one embodiment, and FIG. 2 shows a side view of electronic locker 100 in accordance with one embodiment. One or more features and/or one or more components depicted in FIG. 1 have been omitted for clarity from FIG. 2.

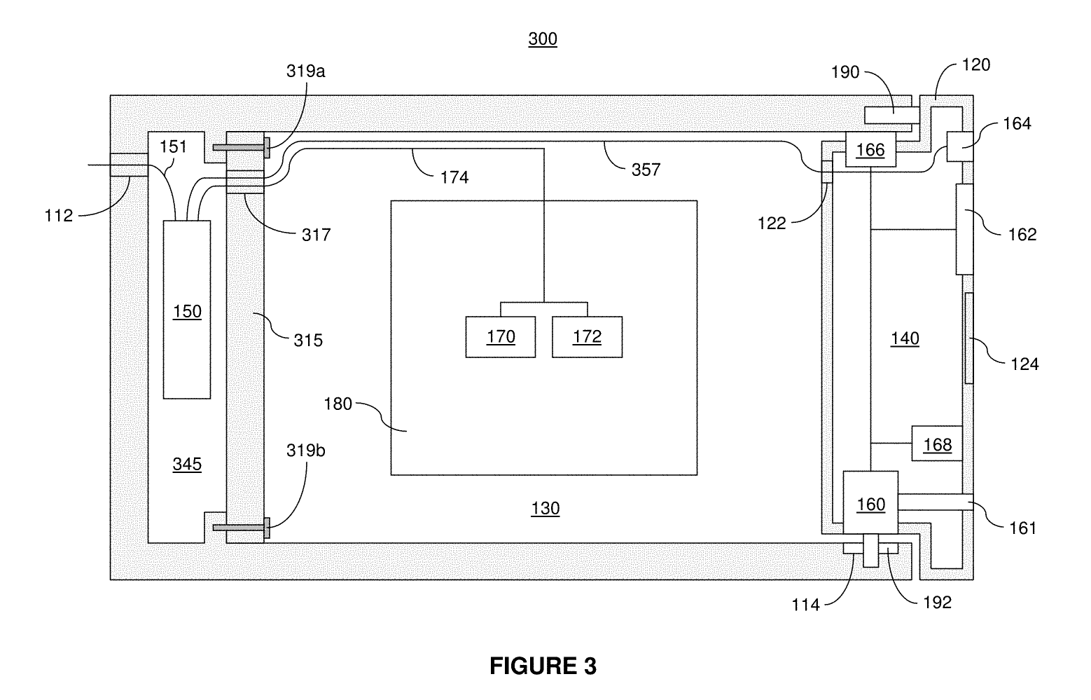

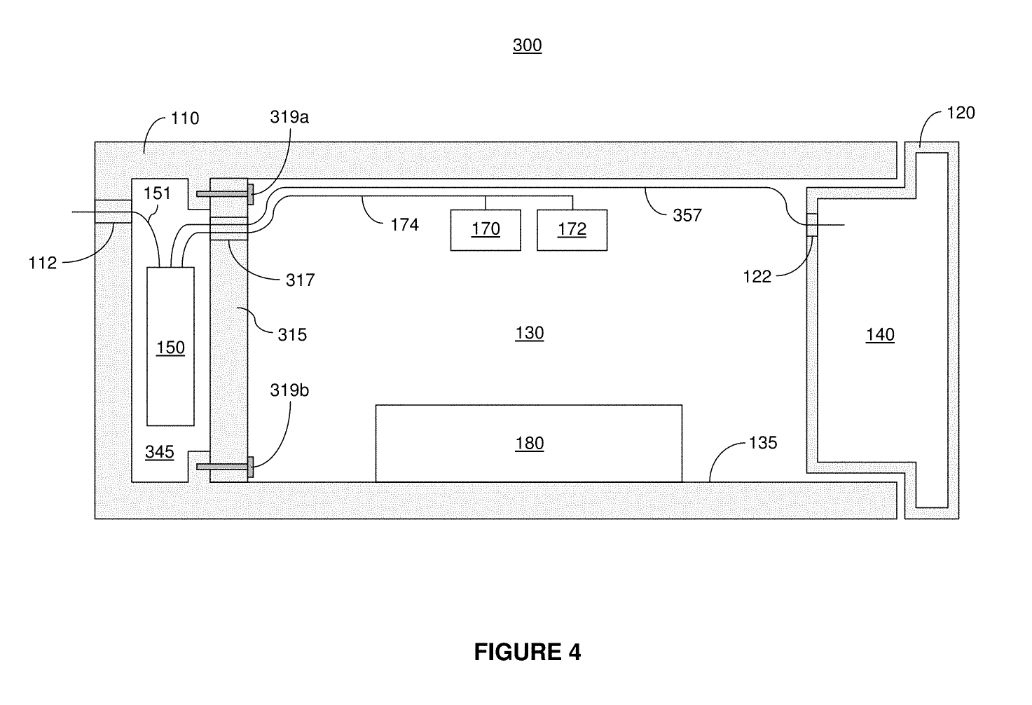

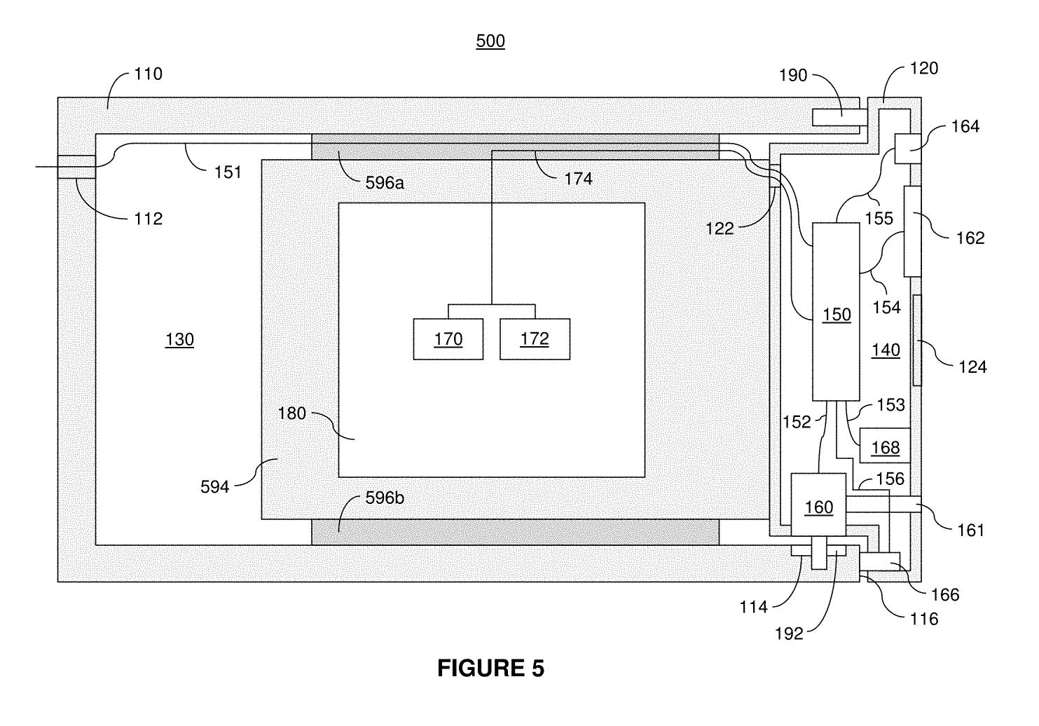

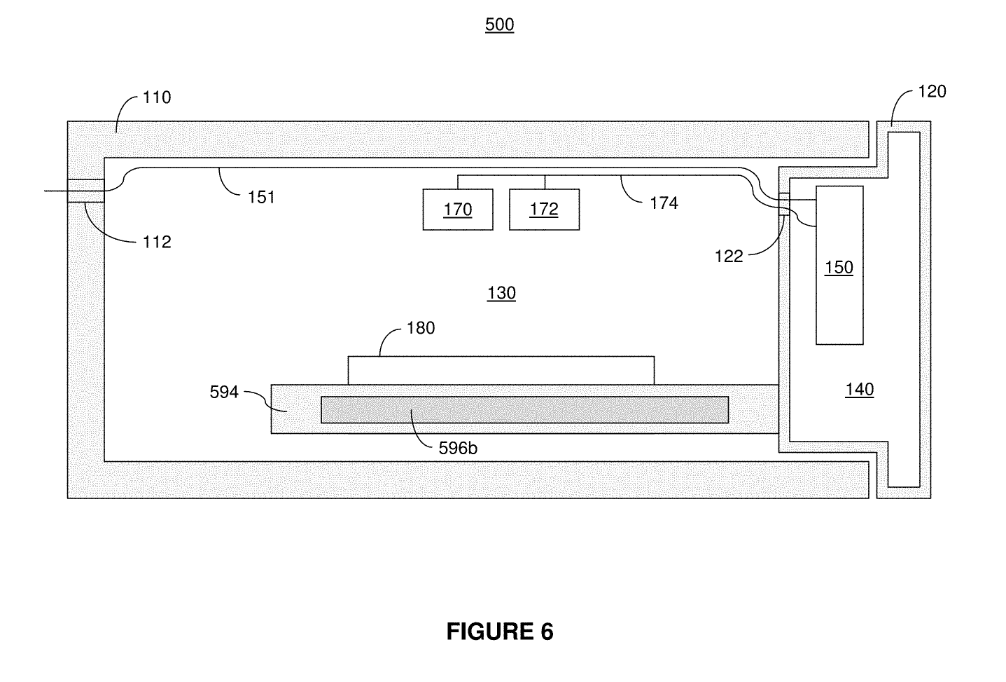

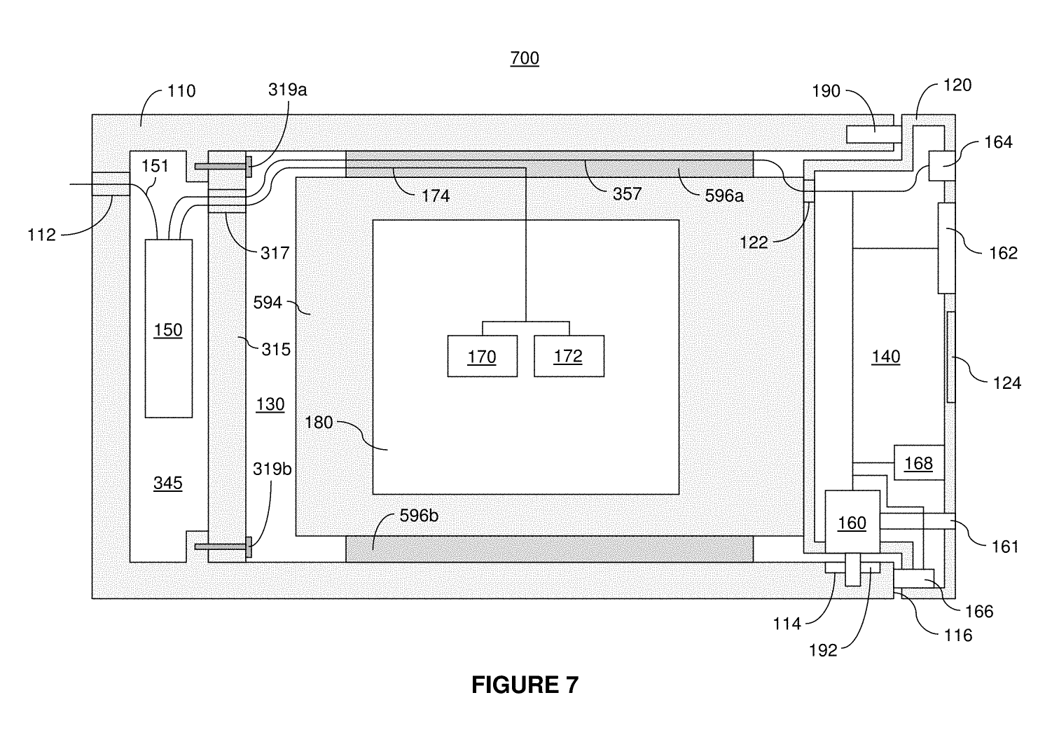

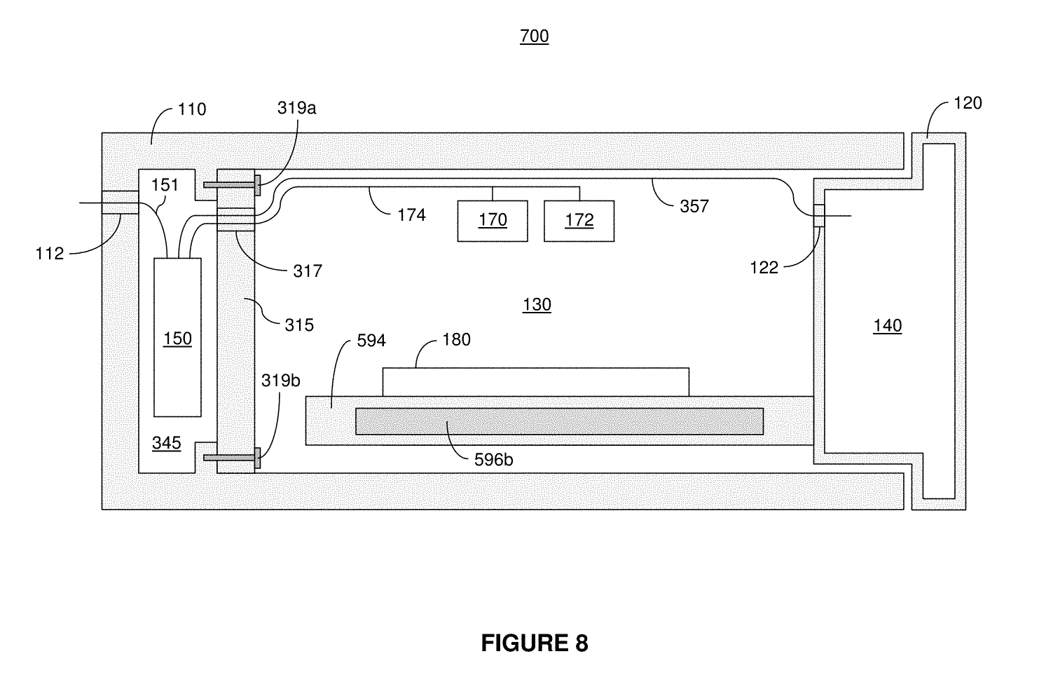

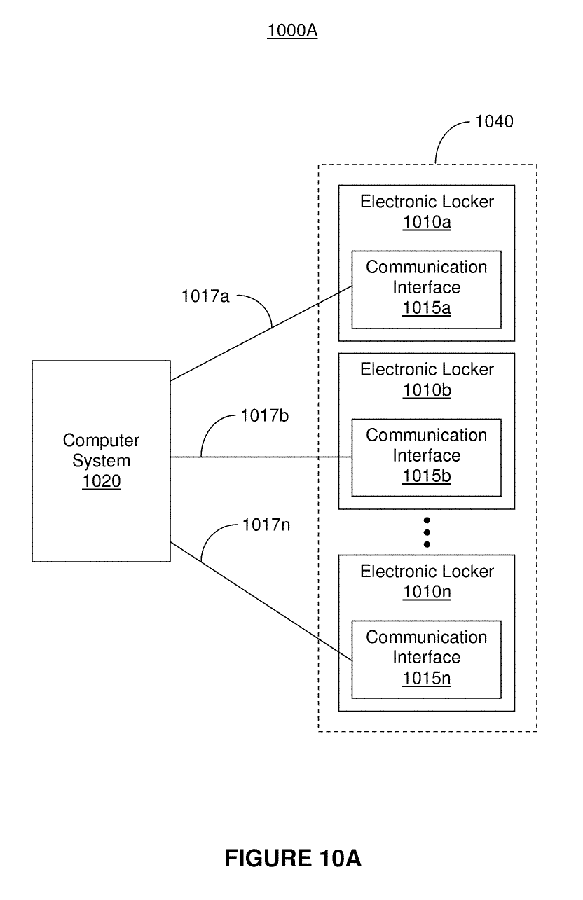

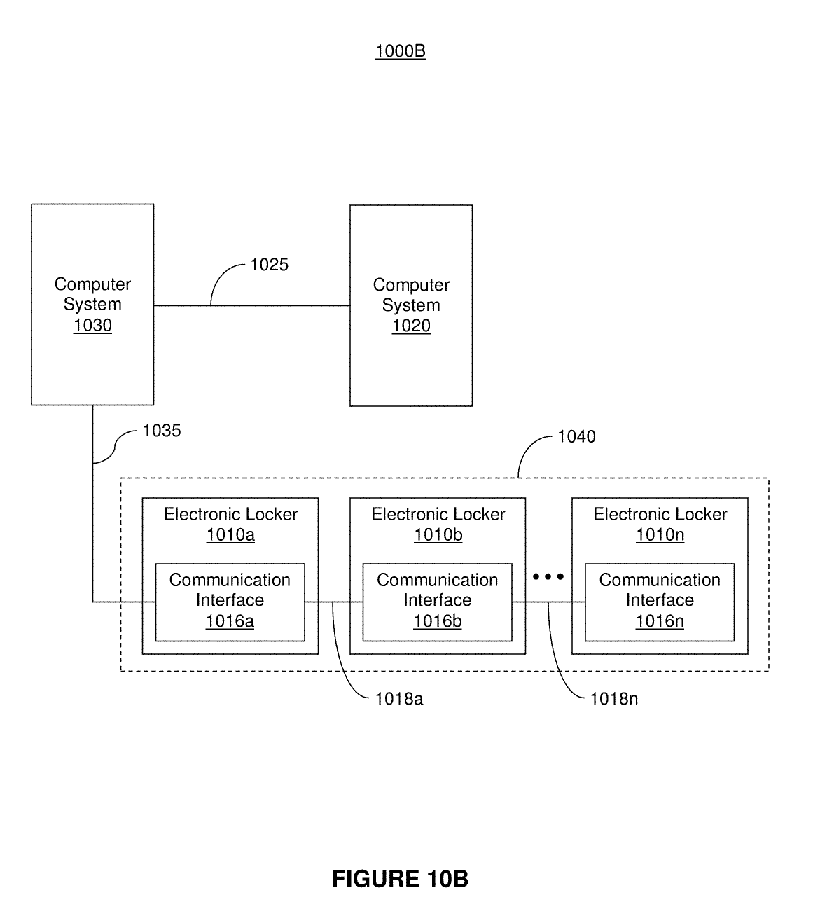

In one embodiment, a kiosk (e.g., 1040 of FIG. 10A and/or FIG. 10B, including one or more electronic lockers such as electronic locker 100 of FIGS. 1 and 2, electronic locker 300 of FIGS. 3 and 4, electronic locker 500 of FIGS. 5 and 6, electronic locker 700 of FIGS. 7 and 8, at least one of electronic lockers 1010a through 1010n of FIGS. 10A and 10B, etc.) may be operated in environments and locations that have security and surveillance levels that approximate those of bank ATMs. A user may walk into such a location and operate an electronic locker of the kiosk to store and retrieve the valuables. The kiosk may use a secure multi-factor authorization mechanism that may prevent unauthorized access to and/or opening of the electronic locker (e.g., 100, 200, 300, 1010a, 1010b, etc.) either by mistake or through criminal intent. A linkage may be provided to the institution's user records system to allow tracking of the persons using the facility in a similar manner as a bank tracks its users through a know your customer (KYC) process. This may reduce use of the electronic locker (e.g., 100, 200, 300, 1010a, 1010b, etc.) for illegal purposes. An optional visual tracking mechanism may allow a user to view the contents of an electronic locker (e.g., 100, 200, 300, 1010a, 1010b, etc.) which may provide additional comfort regarding the safety of their valuables in the electronic locker. A peripheral surveillance system with internal power backup and wireless internet connectivity may be capable of alerting a central monitoring station (e.g., computer system 1020 of FIGS. 10A and 10B computer system 1030 of FIG. 10B etc.) if any distress (vibration, heat from blow-torch, hammer impact etc.) is detected on or around the kiosk.

In one embodiment, a system (e.g., 1000A of FIG. 10A, 1000B of FIG. 10B, etc.) may merge enterprise applications (e.g., customer relationship management (CRM), loan management systems, etc.) with at least one Internet of things (IOT) based secured and integrated electronic locker to provide kiosk type facilities for authorized storage and retrieval of valuables. Accordingly, one or more embodiments may allow institutions to provide such services to their users.

In one embodiment, an electronic locker (e.g., 100, 200, 300, 1010a, 1010b, etc.) may be used to implement modular hardware that can be customized using software to control access to at least one item (e.g., 180 of FIGS. 1 through 8) disposed within the electronic locker. The modular hardware may be arranged in any combination to be re-purposed for different needs. The software may change the access and monitoring mechanism for various use cases. In one embodiment, an electronic locker (e.g., 100, 200, 300, 1010a, 1010b, etc.) may operate similar to a PC with or without the Operating System (OS). In one embodiment, by changing the software, the modular hardware may play different roles. For example, it may be used to implement a secure gold deposit which may require multiple key combinations from multiple stakeholders for access, or alternatively, it may be used to implement a simple single stakeholder based access.

As shown in FIGS. 1 and 2, electronic locker 100 may include outer shell or housing 110 and member 120. Housing 110 may define compartment 130. Housing 130 may be configured to hold or accept at least one item 180 (e.g., gold or other valuables, one or more bags, one or more other objects, etc.) within compartment 130 (e.g., on or at surface 135 of compartment 130 as depicted in FIGS. 2 and 4). In one embodiment, member 120 may be coupled with housing 110. Member 120 may define container 140. And in one embodiment, member 120 may be configured to provide access to compartment 130 in a first state (e.g., when member 120 is opened with respect to housing 110 and/or moved away from housing 110), and member 120 may be configured to restrict access to compartment 130 in a second state (e.g., when member 120 is closed with respect to housing 110 and/or moved toward housing 110).

Electronic locker 100 may include one or more electronic components. For example, electronic locker 100 may include circuitry 150, electronic lock 160, at least one sensor (e.g., door ajar sensor 166, vibration sensor 168, etc.), at least one output device (e.g., visual output device 162, audio output device 164, etc.), at least one camera 170, at least one light source 172, at least one interface (e.g., 151, 152, 153, 154, 155, 156, 174, etc.), some combination thereof, etc. One or more of these electronic components may be disposed at least partially within container 140 in one embodiment.

Member 120 may be configured to limit unauthorized access to container 140 in one embodiment. For example, member 120 may be configured to provide access to container 140 in a first state (e.g., when member 120 is opened with respect to housing 110 and/or moved away from housing 110), and member 120 may be configured to restrict access to container 140 in a second state (e.g., when member 120 is closed with respect to housing 110 and/or moved toward housing 110).

In one embodiment, electronic lock 160 may be controlled to implement a first state (e.g., when member 120 is opened with respect to housing 110 and/or moved away from housing 110) and/or a second state (e.g., when member 120 is closed with respect to housing 110 and/or moved toward housing 110) by circuitry 150 (e.g., via interface 152) and/or by a computer system (e.g., computer system 1020 of FIGS. 10A and 10B computer system 1030 of FIG. 10B, etc.). In one embodiment, at least one interface 151 may be electrically coupled with another electronic locker (e.g., 300, 500, 700, 1010a, 1010b, etc.) and/or a computer system (e.g., 1020, 1030, etc.), and at least one interface 151 may be routed into housing 110 (e.g., through opening 112 defined in housing 110). At least one interface 151 may be routed between compartment 130 and container 140 (e.g., through opening 122 defined in member 120) in one embodiment. At least one interface 151 may be configured to supply electricity or power to at least one component of electronic locker 100 (e.g., circuitry 150, electronic lock 160, visual output device 162, audio output device 164, door ajar sensor 166, vibration sensor 168, etc.) and/or establish a connection (e.g., a wired connection such as an Ethernet connection, a RS-485 connection, and a RS-232 connection, etc.) between circuitry 150 and a computer system (e.g., computer system 1020 of FIGS. 10A and 10B computer system 1030 of FIG. 10B, etc.). As such, at least one interface 151 may be configured to allow control of electronic lock 160 (e.g., by circuitry 150 and/or a computer system in communication with circuitry 150).

Electronic lock 160 may be controlled based on at least one authentication mechanism in one embodiment. For example, electronic lock 160 may be unlocked and/or controlled to implement a first state (e.g., an unsecure state where member 120 is opened with respect to housing 110 and/or moved away from housing 110) based on one or more authentication mechanisms such as biometric authentication (e.g., fingerprint authentication, etc.), SMS authentication, authentication based on a digital signature that is unique to electronic lock 160 and/or the electronic locker, authentication based on an electronic key, authentication based on an electronic password, some combination thereof, etc.

In one embodiment, a multi-factor authentication mechanism may be used to control a state of electronic lock 160. The multi-factor authentication mechanism may require authentication of more than one person, where each person is authenticated using one or more authentication mechanisms such as biometric authentication (e.g., fingerprint authentication, etc.), SMS authentication, authentication based on a digital signature that is unique to electronic lock 160 and/or the electronic locker, authentication based on an electronic key, authentication based on an electronic password, some combination thereof, etc. For example, to unlock electronic lock 160 and gain access to at least one item 180, authentication of the person depositing at least one item 180 and at least one other person or entity (e.g., the kiosk agent, the loan company that may be based in a remote office or location, some combination thereof, etc.) may be required.

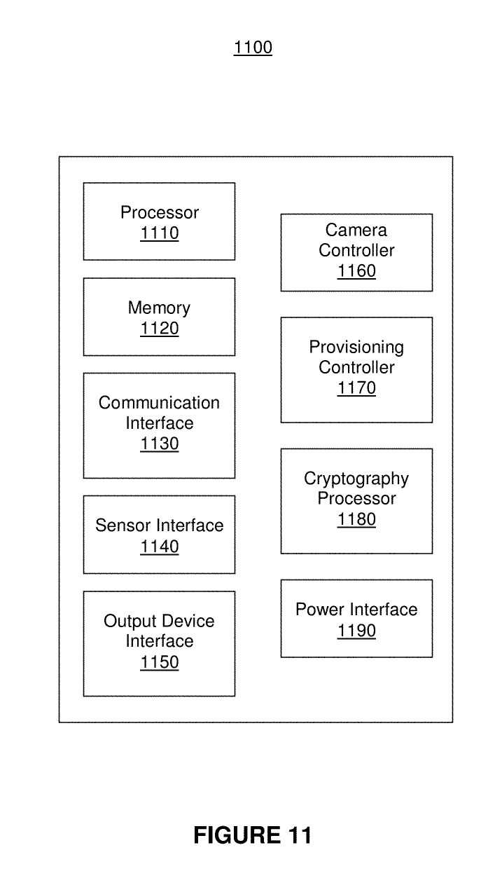

Circuitry 150 may include a communication interface (e.g., at least one of communication interfaces 1015a through 1015n of FIG. 10A, at least one of communication interfaces 1016a through 1016n of FIG. 10B, 1130 of FIG. 11, etc.) configured to establish a connection between circuitry 150 and another system or device in one embodiment. For example, the communication interface may be configured to establish a connection between circuitry 150 and at least one computer system (e.g., computer system 1020 of FIGS. 10A and 10B, computer system 1030 of FIG. 10B, etc.), at least one other electronic locker (e.g., one or more of electronic lockers 1010a through 1010n of FIG. 10A and/or FIG. 10B), etc. The connection established using the communication interface may be wired (e.g., implemented using at least one interface 151 which may be electrically coupled with the communication interface) and/or wireless. In one embodiment, where the connection includes a wireless connection, electronic lock 160 may be controlled by a computer system (e.g., computer system 1020 of FIGS. 10A and 10B, computer system 1030 of FIG. 10B, etc.) using the wireless connection. And in one embodiment, circuitry 150 may be implemented using at least a portion of circuitry 1100 of FIG. 11.

In one embodiment, circuitry 150 may be or be implemented using a panel (e.g., including at least one printed circuit board), a control board, an electronic main board, a motherboard, etc. Circuitry 150 may include one or more electrical connectors (e.g., each including at least one plug and/or at least one socket). Circuitry 150 may include a processor (e.g., 1110 of FIG. 11) in one embodiment. And in one embodiment, a processor of circuitry 150 may be or be implemented using a controller, a microcontroller, a microprocessor, a central processing unit (CPU), a main processor, etc.

Circuitry 150 may be connected with a central command (e.g., computer system 1020 of FIGS. 10A and 10B) either directly or via an intermediary (e.g., computer system 1030 of FIG. 10B) for information exchange. The communication with the central command can be carried out over any media (e.g. wired or wireless) and using any protocol (e.g., HTTP, CoAP, etc.). Thus, an electronic locker (e.g., 100, 200, 300, 1010a, 1010b, etc.) can be remotely monitored and/or controlled from a remote location at one or more times.

In one embodiment, an electronic locker (e.g., 100, 200, 300, 1010a, 1010b, etc.) may be able to create a unique digital signature. The unique digital signature may be difficult or impossible to copy and/or clone in one embodiment. As such, it may be difficult or impossible for unauthorized parties to access (e.g., by generating electronic signals or otherwise) the electronic locker.

Visual output device 162 may include at least one light emitting component (e.g., at least one light emitting diode (LED), etc.) configured to output one or more colors, a display (e.g., a liquid crystal display (LCD) or other display capable of presenting text and/or graphics), another type of visual output device, or some combination thereof. In one embodiment, visual output device 162 may be located at a front face of member 120. And in one embodiment, visual output device 162 may display or otherwise indicate the status of electronic lock 160 (e.g., locked or unlocked), the electronic locker (e.g., member 120 is open or closed with respect to housing 110, one or more components of the electronic locker are active and/or in proper condition, an error has occurred with respect to one or more components of the electronic locker, an alert is to be communicated, etc.).

In one embodiment, electronic lock 160 may be configured to limit relative movement between member 120 and housing 110 in a second state (e.g., when member 120 is closed with respect to housing 110 and/or moved toward housing 110). For example, electronic lock 160 may be coupled with member 120, and electronic lock 160 may engage or interface with a portion of housing 110 responsive to actuation of electronic lock 160.

Electronic lock 160 may be or include an electromagnetic lock in one embodiment. And in one embodiment, electronic lock 160 may be or include a solenoid.

In one embodiment, electronic locker 100 may include lock strike 192. Lock strike 192 may fit at least partially within and/or be supported by channel 114 defined by housing 110.

Electronic lock 160 may be actuated (e.g., locked or unlocked, opened or closed, etc.) via software control present in circuitry 150 in one embodiment. Electronic lock 160 may support both fail-secure and fail-safe designs in one embodiment.

In one embodiment, electronic locker 100 may include manual key override 161. Manual key override 161 may be positioned behind or at least partially within a keyhole or other opening defined in member 120 in one embodiment. Manual key override 161 may be used for maintenance and/or repair in one embodiment.

Electronic locker 100 may include one or more sensors to assist in securing at least one item 180. For example, vibration sensor 168 may sense any unusual vibration of electronic locker 100 or a component thereof (e.g., housing 110, member 120, etc.). If any is detected, circuitry 150 may inform a central command (e.g., computer system 1020 of FIGS. 10A and 10B) about such suspicious activities related to electronic locker 100.

In one embodiment, door ajar sensor 166 may keep track of whether member 120 is opened or closed (e.g., with respect to housing 110). Door ajar sensor 166 may be or include a tactile switch in one embodiment. And in one embodiment, electronic locker 100 may send heartbeat messages at regular intervals, and the status of member 120 may be communicated to a central command (e.g., computer system 1020 of FIGS. 10A and 10B).

Audio output device 164 may provide audio feedback to an agent managing electronic locker 100 in one embodiment. In one embodiment, audio output device 164 may be a speaker, a buzzer or buzzer-type device, a text-to-speech converter configured to output audio indications via speech, some combination thereof, etc.

In one embodiment, at least one camera 170 may be configured to capture at least one image of at least one item 180. For example, at least one camera 170 and/or at least one light source 172 may be positioned toward a ceiling of housing 110 (e.g., by fitting at least one camera 170 and/or at least one light source 172 on the top wall of the housing 110, using interface 174 to hold at least one camera 170 and/or at least one light source 172 in or toward the top of compartment 130, etc.) and pointed down toward at least one item 180 (e.g., as depicted in FIG. 2, FIG. 4, etc.).

At least one camera 170 may be electrically coupled with circuitry 150 via interface 174. In one embodiment, at least one camera 170 may be coupled with a camera controller (e.g., 1160 of FIG. 11) of circuitry 150 via interface 174. Interface 174 may be or be implemented using a cable in one embodiment. Interface 174 may be routed between compartment 130 and container 140 (e.g., through opening 122 defined in member 120).

One or more captured images may be transmitted to a central command (e.g., computer system 1020 of FIGS. 10A and 10B) or to identified stakeholders in one embodiment. For example, one or more captured images may be communicated from circuitry 150 over a connection (e.g., a wired connection implemented using at least one interface 151 and/or a communication interface of circuitry 150, a wireless connection implemented using a communication interface of circuitry 150, etc.) to a computer system (e.g., computer system 1020 of FIGS. 10A and 10B, computer system 1030 of FIG. 10B, etc.). Accordingly, one or more embodiments may advantageously allow remote monitoring of at least one item 180 and/or compartment 130. The one or more captured images may provide a visual indication to the stakeholders about the contents of compartment 130.

Additionally, one or more embodiments may advantageously allow implementation of a peripheral surveillance system which can alert a central monitoring station (e.g., computer system 1020 of FIGS. 10A and 10B, computer system 1030 of FIG. 10B, etc.) in case of distress detected on or around the electronic locker (e.g., 100, 200, 300, 1010a, 1010b, etc.) such as tampering, electrical failure, etc.

In one embodiment, at least one light source 172 may be a flashlight or other light source configured to illuminate at least one item 180 or otherwise allow at least one camera 170 to capture one or more images of at least one item 180 and/or compartment 130. In one embodiment, at least one light source 172 may be provided with at least one camera 170.

Electronic locker 100 may include at least one component 190 configured to automatically open member 120 with respect to housing 110 and/or automatically push member 120 away from housing 110. In one embodiment, at least one component 190 may include one or more springs.

In one embodiment, member 120 may define at least one feature 124 configured to allow manual (e.g., using at least one finger, hand, etc.) opening of member 120 with respect to housing 110 and/or manual (e.g., using at least one finger, hand, etc.) movement of member 120 away from housing 110. In one embodiment, at least one feature 124 may be a notch.

FIG. 3 shows a top view of electronic locker 300 defining multiple containers in accordance with one embodiment, and FIG. 4 shows a side view of electronic locker 300 defining multiple containers in accordance with one embodiment. One or more features and/or one or more components depicted in FIG. 3 have been omitted for clarity from FIG. 4. In one embodiment, electronic locker 300 may include one or more features, one or more components, etc. of electronic locker 100.

As shown in FIGS. 3 and 4, electronic locker 300 may define container 140 and container 345. Containers 140 and 345 may be defined at opposite ends of electronic locker 300 in one embodiment.

In one embodiment, container 345 may be defined by housing 110 and member 315. Member 315 may be removably coupled with housing 315 by one or more fasteners (e.g., 319a, 319b, etc.). In one embodiment, the one or more fasteners (e.g., 319a, 319b, etc.) may be screws. And in one embodiment, member 315 may be detached and/or removed from the inside of housing 110 (e.g., by loosening and/or removing at least one fastener such as fastener 319a, 319b, etc. from within compartment 130). In this manner, member 315 may be detached and/or removed to provide access to container 345 and/or one or more components disposed therein.

As shown in FIGS. 3 and 4, circuitry 150 may be disposed at least partially within container 345. Circuitry 150 may be electrically coupled via at least one interface 357 with one or more electronic components disposed at least partially within container 140 (e.g., electronic lock 160, visual output device 162, audio output device 164, door ajar sensor 166, vibration sensor 168, some combination thereof, etc.). As shown in FIGS. 3 and 4, interface 174 may be routed between compartment 130 and container 345 (e.g., through opening 317 defined in member 315).

In one embodiment, at least one interface 357 may provide electricity or power to the one or more electronic components disposed at least partially within container 140. In one embodiment, at least one interface 357 may allow the one or more electronic components disposed at least partially within container 140 to be controlled (e.g., by circuitry 150 and/or a computer system in communication with circuitry 150 such as computer system 1020 of FIGS. 10A and 10B computer system 1030 of FIG. 10B, etc.). And in one embodiment, at least one interface 357 may be routed between container 345 and container 140 (e.g., through opening 317 defined in member 315, through compartment 130, and through opening 122 defined in member 120).

One or more of the interfaces of at least one interface 357 may include circuitry and/or components in one embodiment. For example, one or more of the interfaces of at least one interface 357 may include a panel (e.g., including at least one printed circuit board), at least one electrical connector (e.g., each including at least one plug and/or at least one socket), etc. In one embodiment, the circuitry and/or components of at least one interface 357 may be disposed at least partially within container 140. And in one embodiment, circuitry 150 (e.g., disposed at least partially within container 345 as shown in FIGS. 3 and 4) may be electrically coupled with one or more electronic components disposed at least partially within container 140 (e.g., electronic lock 160, visual output device 162, audio output device 164, door ajar sensor 166, vibration sensor 168, some combination thereof, etc.) via the circuitry and/or components of at least one interface 357.

In one embodiment, member 120 may be or be configured to implement a door (e.g., as depicted in FIGS. 1 through 4). Alternatively, member 120 may be or be configured to implement a drawer front of a drawer (e.g., as depicted in FIGS. 5 through 8).

FIG. 5 shows a top view of electronic locker 500 including a drawer in accordance with one embodiment, and FIG. 6 shows a side view of electronic locker 500 including a drawer in accordance with one embodiment. One or more features and/or one or more components depicted in FIG. 5 have been omitted for clarity from FIG. 6. In one embodiment, electronic locker 500 may include one or more features, one or more components, etc. of electronic locker 100 and/or electronic locker 300.

As shown in FIGS. 5 and 6, electronic locker 500 may include base 594 and at least channel (e.g., channel 596a, channel 596b, etc.). Base 594 may be coupled with member 120, and base 594 may be configured to accept at least one item 180. In one embodiment, base 594 and member 120 may be configured to implement a drawer. The at least one channel (e.g., channel 596a, channel 596b, etc.) may be coupled with housing 110 and base 594, and the at least one channel (e.g., channel 596a, channel 596b, etc.) may be configured to allow member 120 and base 594 to move (e.g., slide out/open or slide in/closed) with respect to housing 110.

As shown in FIG. 5, door ajar sensor 166 may be positioned such that it can detect movement (e.g., sliding out/open or sliding in/closed) of member 120 with respect to housing 110. For example, door ajar sensor 166 may be positioned at or in proximity to a surface of housing 110 (e.g., surface 116) which is approximately perpendicular to an axis of movement of member 120 in one embodiment.

FIG. 7 shows a top view of electronic locker 700 defining multiple containers and including a drawer in accordance with one embodiment, and FIG. 8 shows a side view of electronic locker 700 defining multiple containers and including a drawer in accordance with one embodiment. One or more features and/or one or more components depicted in FIG. 7 have been omitted for clarity from FIG. 8. In one embodiment, electronic locker 700 may include one or more features, one or more components, etc. of electronic locker 100, electronic locker 300, electronic locker 500, or some combination thereof.

As shown in FIGS. 7 and 8, at least one interface 357 may be or be implemented using a cable in one embodiment. The cable may span from container 345 to container 140 in one embodiment. The cable may be a flat ribbon cable (FRC) in one embodiment. And in one embodiment, the cable may be flexible such that at least one interface 357 can deform (e.g., bend, expand, contract, etc.) as member 120 and/or base 594 is moved with respect to housing 110.

In one embodiment, where at least one interface 357 is or is implemented using a FRC, at least one electrical connector of circuitry 150 may be or include at least one FRC connector (e.g., each including at least one FRC plug and/or at least one FRC socket). As such, at least one interface 357 may couple to circuitry 150 (e.g., at least partially within container 345) via at least one FRC connector.

In one embodiment, where at least one interface 357 is or is implemented using a FRC and where one or more of the interfaces of at least one interface 357 includes at least one electrical connector disposed at least partially within container 140, at least one electrical connector of at least one interface 357 may be or include at least one FRC connector. As such, at least one interface 357 may be electrically coupled with one or more electronic components disposed at least partially within container 140 (e.g., electronic lock 160, visual output device 162, audio output device 164, door ajar sensor 166, vibration sensor 168, some combination thereof, etc.) via at least one FRC connector. And in one embodiment, where at least one interface 357 includes at least one FRC connector and a panel disposed at least partially within container 140, circuitry 150 (e.g., disposed at least partially within container 345 as shown in FIGS. 7 and 8) may be electrically coupled with one or more electronic components disposed at least partially within container 140 (e.g., electronic lock 160, visual output device 162, audio output device 164, door ajar sensor 166, vibration sensor 168, some combination thereof, etc.) via the at least one FRC connector and the panel (e.g., where the at least one FRC connector is coupled with the panel).

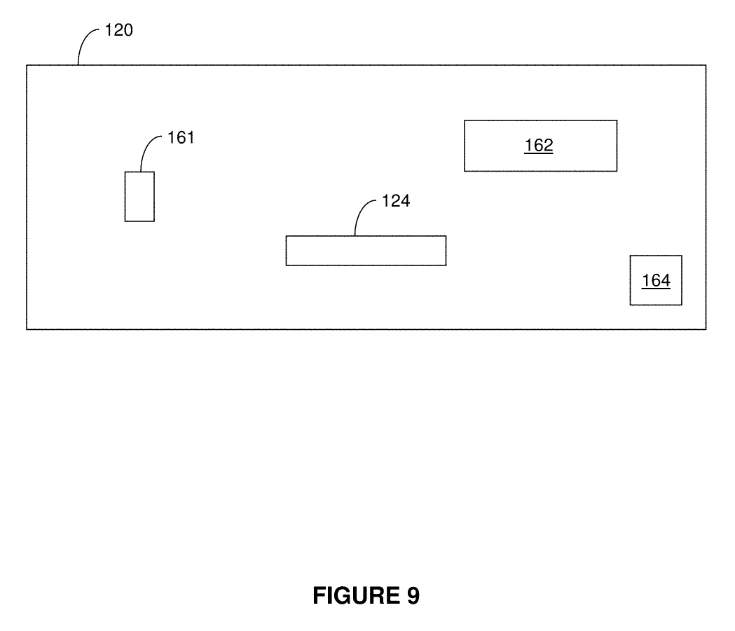

FIG. 9 shows a front face of member 120 in accordance with one embodiment. As shown in FIG. 9, one or more features (e.g., 124) and/or one or more electronic components (e.g., manual key override 161, visual output device 162, audio output device 164, some combination thereof, etc.) may be visible and/or accessible from a front face of member 120.

FIG. 10A shows system 1000A including a plurality of electronic lockers in accordance with one embodiment. In one embodiment, system 1000A may be or be configured to implement a private intranet. A plurality of electronic lockers (e.g., 1010a, 1010b, etc.) may be or be configured to implement kiosk 1040 in one embodiment. And in one embodiment, computer system 1020 may be or be configured to implement a central command, a central monitoring station, a computer system for remotely monitoring one or more electronic lockers (e.g., 1010a, 1010b, etc.), etc.

As shown in FIG. 10A, a plurality of electronic lockers (e.g., 1010a, 1010b, etc.) may communicate with computer system 1020 over respective connections (e.g., 1017a, 1017b, etc.). Each connection (e.g., 1017a, 1017b, etc.) may be a wired connection (e.g., an Ethernet connection, a RS-485 connection, and a RS-232 connection, etc.) and/or a wireless connection. In one embodiment, each electronic locker (e.g., 1010a, 1010b, etc.) may include a respective communication interface (e.g., 1015a, 1015b, etc.) configured to establish a respective connection (e.g., 1017a, 1017b, etc.) between the electronic locker and computer system 1020.

FIG. 10B shows system 1000B including a plurality of electronic lockers in at least one daisy chain configuration in accordance with one embodiment. A plurality of electronic lockers (e.g., 1010a, 1010b, etc.) may be or be configured to implement kiosk 1040 in one embodiment. In one embodiment, computer system 1020 may be or be configured to implement a central command, a central monitoring station, a computer system for remotely monitoring one or more electronic lockers (e.g., 1010a, 1010b, etc.), etc. And in one embodiment, computer system 1030 may be or be configured to implement an embedded PC, an intermediary computer system between computer system 1020 and at least one electronic locker (e.g., 1010a, 1010b, etc.), etc.

As shown in FIG. 10B, a plurality of electronic lockers (e.g., 1010a, 1010b, etc.) may be connected in a daisy chain configuration to allow communication with a computer system (e.g., 1020, 1030, etc.). In one embodiment, communications may be sent between a computer system (e.g., 1020, 1030, etc.) and an electronic locker (e.g., 1010a, 1010b, etc.) over connections between the electronic lockers (e.g., connection 1018a, etc.) and/or at least one connection with a computer system (e.g., connection 1025, connection 1035, etc.).

For example, communications between computer system 1030 and electronic locker 1010a may be sent over connection 1035, and communications between computer system 1030 and electronic locker 1010b may be sent over connection 1035 and connection 1018a. As another example, communications between computer system 1020 and electronic locker 1010a may be sent over connection 1025 and connection 1035, and communications between computer system 1020 and electronic locker 1010b may be sent over connection 1025, connection 1035, and connection 1018a.

In one embodiment, each connection (e.g., 1025, 1035, 1018a, etc.) may be a wired connection (e.g., an Ethernet connection, a RS-485 connection, and a RS-232 connection, etc.) and/or a wireless connection. In one embodiment, each electronic locker (e.g., 1010a, 1010b, etc.) may include a respective communication interface (e.g., 1016a, 1016b, etc.) configured to establish one or more connections (e.g., 1025, 1035, 1018a, etc.) with another electronic locker and/or a computer system (e.g., 1020, 1030, etc.).

Each connection (e.g., 1025, 1035, 1018a, etc.) may include at least one interface configured to supply electricity or power to one or more electronic lockers (e.g., 1010a, 1010b, etc.) in one embodiment. For example, electricity or power may be supplied to electronic locker 1010a (e.g., from computer system 1020 and/or computer system 1030) using connection 1025 and/or connection 1035. As another example, electricity or power may be supplied to electronic locker 1010b (e.g., from computer system 1020, computer system 1030, electronic locker 1010a, some combination thereof, etc.) using connection 1025, connection 1035, connection 1018a, some combination thereof, etc.

In one embodiment, at least one other electronic locker may communicate with and/or receive electricity or power from computer system 1030. The at least one other electronic locker may communicate with and/or receive electricity or power from computer system 1030 over a connection separate from connection 1035 in one embodiment. And in one embodiment, the at least one other electronic locker may include a plurality of electronic lockers in a daisy chain configuration (e.g. similar to electronic lockers 1010a, 1010b, etc.), and therefore, system 1000B may include a plurality of electronic lockers in multiple daisy chain configurations.

FIG. 11 shows circuitry 1100 in accordance with one embodiment. As shown in FIG. 11, circuitry 1100 may include processor 1110, memory 1120, communication interface 1130, sensor interface 1140, output device interface 1150, camera controller 1160, provisioning controller 1170, cryptography processor 1180, power interface 1190, or some combination thereof.

In one embodiment, processor 1110 may be or be used to implement a controller, a microcontroller, a microprocessor, a central processing unit (CPU), a main processor, etc. And in one embodiment, processor 1110 may control or be used to implement one or more operations related to an electronic locker (e.g., 100, 300, 500, 700, 1010a, 1010b, etc.). For example, processor 1110 (e.g., alone or in combination with at least one other component of circuitry 1100) may control or be used to implement locking of electronic lock 160 (e.g., initiated locally using one or more components of the electronic locker and/or initiated remotely using a computer system such as computer system 1020 and/or computer system 1030), unlocking of electronic lock 160 (e.g., initiated locally using one or more components of the electronic locker, initiated remotely using a computer system such as computer system 1020 and/or computer system 1030, based on results of authentication performed by cryptography processor 1180 and/or another component of circuitry 1100 and/or a computer system such as computer system 1020 or computer system 1030, some combination thereof, etc.), monitoring and/or surveillance of at least one item 180 (e.g., using at least one camera 170, at least one light source 172, interface 174, camera controller 1160, communication interface 1130, memory 1120, another component, some combination thereof, etc.), monitoring (e.g., using door ajar sensor 166, vibration sensor 168, sensor interface 1140, memory 1120, communication interface 1130, another component, some combination thereof, etc.) and/or communication of information related to at least one parameter associated with the electronic locker (e.g., vibration, an opening of a member such as member 120 with respect to a housing such as housing 110, a closing of a member such as member 120 with respect to a housing such as housing 110, an electrical failure, etc.), providing an alert or otherwise outputting information (e.g., using visual output device 162, audio output device 164, etc.), another operation, some combination thereof, etc.

Memory 120 may store data or information, and memory 120 may be removable (e.g., a Secure Digital (SD) card, etc.) or non-removable. Memory 120 may be accessed by one or more components of circuitry 1100 in one embodiment.

In one embodiment, communication interface 1130 may be used to establish or implement a wired connection and/or a wireless connection with another system (e.g., electronic locker 100, electronic locker 300, electronic locker 500, electronic locker 700, electronic locker 1010a, electronic locker 1010b, computer system 1020, computer system 1030, etc.) and/or communication interface (e.g., of electronic locker 100, of electronic locker 300, of electronic locker 500, of electronic locker 700, 1015a, 1015b, 1016a, 1016b, etc.). And in one embodiment, communication interface 1130 may be or be configured to implement a communication interface of electronic locker 100, a communication interface of electronic locker 300, a communication interface of electronic locker 500, a communication interface of electronic locker 700, communication interface 1015a, communication interface 1015b, communication interface 1016a, communication interface 1016b, etc.

Sensor interface 1140 may be configured to communicate with and/provide electricity or power to one or more sensors (e.g., door ajar sensor 166, vibration sensor 168, etc.). Output device interface 1150 may be configured to communicate with and/provide electricity or power to one or more output devices (e.g., visual output device 162, audio output device 164, etc.).

Camera controller 1160 may be configured to communicate with and/provide electricity or power to at least one camera 170 and/or at least one light source 172. In one embodiment, camera controller 1160 (e.g., either alone or in combination with processor 1110 and/or at least one other component of circuitry 1100) may control or allow capturing of at least one image, communication or transmission of at least one image to another system (e.g., computer system 1020, computer system 1030, etc.), etc.

Provisioning controller 1170 may allow provisioning of an electronic locker (e.g., 100, 300, 500, 700, 1010a, 1010b, etc.). In one embodiment, provisioning controller 1170 may include or be configured to implement an interface allowing connection of and/or communication with an external computer system. In this manner, an electronic locker can be provisioned using an external computer system via provisioning controller 1170.

Cryptography processor 1180 may perform or be used (e.g., by another component of circuitry 1100) to perform one or more security-related operations. For example, cryptography processor 1180 may perform encryption, decryption, cryptographic functions, hashing, authentication, validation, etc. In one embodiment, cryptography processor 1180 may perform authentication of one or more individuals or entities (e.g., single-factor authentication and/or multi-factor authentication) using an authentication mechanism (e.g., biometric authentication, SMS authentication, authentication based on a digital signature that is unique to electronic lock 160 and/or the electronic locker, authentication based on an electronic key, authentication based on an electronic password, some combination thereof, etc.).

In one embodiment, cryptography processor 1180 may include a security chip (e.g., an ATSHA204 or another type of security device) which is configured to be installed or replaced during provisioning of the electronic locker, where provisioning of the electronic locker may be performed using provisioning controller 1170 and/or at least one other component of circuitry 1100. And in one embodiment, the security chip may be removably coupled (e.g., using a breakout and/or inserted into a socket) to at least one other component of circuitry 1100.

Power interface 1190 may provide electricity or power to one or more components of circuitry 1100 and/or an electronic locker (e.g., 100, 300, 500, 700, 1010a, 1010b, etc.). In one embodiment, power interface 1190 may be electrically coupled to at least one interface (e.g., 151, 357, of connection 1025, of connection 1035, of connection 1017a, of connection 1017b, of connection 1018a, etc.) configured to supply electricity or power to at least one component of an electronic locker (e.g., 100, 300, 500, 700, 1010a, 1010b, etc.).

In one embodiment, an electronic locker (e.g., 100, 300, 500, 700, 1010a, 1010b, etc.) may be Internet-based and/or an loT-based locker. An electronic locker (e.g., 100, 300, 500, 700, 1010a, 1010b, etc.) may utilize a low-cost design in one embodiment. In one embodiment, an electronic locker (e.g., 100, 300, 500, 700, 1010a, 1010b, etc.)

may be reusable. In one embodiment, an electronic locker (e.g., 100, 300, 500, 700, 1010a, 1010b, etc.) may utilize modular hardware that can be adapted for different scenarios (e.g., by changing software stored and/or executed using circuitry 1100).

An electronic locker (e.g., 100, 300, 500, 700, 1010a, 1010b, etc.) may be used to secure different types of items. For example, an electronic locker may be used to secure gold or other valuables, one or more bags, one or more other objects, etc.

An electronic locker (e.g., 100, 300, 500, 700, 1010a, 1010b, etc.) may be located in different types of locations. For example, an electronic locker may be located in or around a hospital (e.g., as a hospital kiosk used to secure gold or other valuables), a bank, an airport, a railway station, a gymnasium, a sports complex, a mall (e.g., to secure bags or other items), a place where people congregate, a public place, a home (e.g., for personal use), etc.

In the foregoing specification, embodiments have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction thereto. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. An apparatus comprising:
a housing defining a compartment, wherein said housing is configured to accept at least one item within said compartment;
a member coupled with said housing, wherein said member defines a container, wherein said member is configured to provide access to said compartment in a first state, and wherein said member is further configured to restrict access to said compartment in a second state;
an electronic lock disposed at least partially within said container, wherein said electronic lock is configured to limit relative movement between said member and said housing in said second state; and
an interface routed between said compartment and said container, wherein said interface is configured to allow control of said electronic lock.

2. The apparatus of claim 1 further comprising:
circuitry disposed at least partially within said container, and wherein said circuitry is configured to control said electronic lock to implement said first and second states.

3. The apparatus of claim 2, wherein said circuitry is configured to control said electronic lock using an authentication mechanism selected from a group consisting of biometric authentication, SMS authentication, authentication based on a digital signature that is unique to said electronic lock, authentication based on a digital signature that is unique to said apparatus, authentication based on an electronic key, and authentication based on an electronic password.

4. The apparatus of claim 2, wherein said interface is configured to supply power to said circuitry.

5. The apparatus of claim 2, wherein said circuitry includes a communication interface configured to establish a wireless connection between said circuitry and a computer system separate from said apparatus.

6. The apparatus of claim 2, wherein said interface is configured to establish a connection between said circuitry and a computer system separate from said apparatus.

7. The apparatus of claim 6, wherein said connection is a wired connection selected from a group consisting of an Ethernet connection, a RS-485 connection, and a RS-232 connection.

8. The apparatus of claim 6 further comprising:
a second interface disposed at least partially within said container, and
wherein said circuitry is configured to control said electronic lock using said second interface.

9. The apparatus of claim 8 further comprising:
at least one electronic component disposed at least partially within container; and
a third interface disposed at least partially within said container, and
wherein said circuitry is configured to control said at least one electronic component using said third interface.

10. The apparatus of claim 9, wherein said at least one electronic component is selected from a group consisting of a visual output device and an audio output device.

11. The apparatus of claim 6, wherein said circuitry includes a processor, and further comprising:
at least one sensor configured to monitor a parameter associated with said apparatus, and
wherein said processor is configured to communicate, via said interface over said connection, information associated with said parameter to said computer system.

12. The apparatus of claim 11, wherein said parameter is selected from a group consisting of vibration, an opening of said member with respect to said housing, a closing of said member with respect to said housing, and an electrical failure.

13. The apparatus of claim 6, wherein said circuitry includes a processor, and further comprising:
at least one camera disposed within said compartment, wherein said at least one camera is configured to capture at least one image of said at least one item, and
wherein said processor is configured to communicate, via said interface over said connection, said at least one image to said computer system.

14. The apparatus of claim 13 further comprising:
a cable electrically coupled to said circuitry and said at least one camera, wherein said cable is routed between said compartment and said container.

15. The apparatus of claim 13, wherein said at least one camera is positioned toward a ceiling of said housing.

16. The apparatus of claim 13 further comprising:
at least one light source disposed within said compartment, wherein said at least one light source is configured to illuminate said at least one item.

17. The apparatus of claim 2, wherein said circuitry includes at least one component selected from a group consisting of a processor, a memory, a communication interface, a sensor interface, an output device interface, a camera controller, a provisioning controller, a cryptography processor, and a power interface.

18. The apparatus of claim 17, wherein said processor is selected from a group consisting of a controller, a microcontroller, a microprocessor, a central processing unit, and a main processor.

19. The apparatus of claim 2, wherein said circuitry is selected from a group consisting of a panel, a control board, an electronic main board, and a motherboard.

20. The apparatus of claim 1, wherein said member is configured to implement a door.

21. The apparatus of claim 1 further comprising:
a base coupled with said member, wherein said base is configured to accept said at least one item, and wherein said base and said member are configured to implement a drawer; and
at least one channel coupled with said housing and said base, wherein said at least one channel is configured to allow said member and said base to move with respect to said housing.

22. The apparatus of claim 1, wherein said electronic lock includes a component selected from a group consisting of an electromagnetic lock and a solenoid.
